(19) United States
(12) Patent Application Publication
(10) Pub. No.: US 2025/0111329 A1
(43) Pub. Date: Apr. 3, 2025

(54) Routing Based on Cross-Order Image Recognition

(71) Applicant: Maplebear Inc., San Francisco, CA (US)

(72) Inventors: Shaun Navin Maharaj, Vaughan (CA); Brent Scheibelhut, Toronto (CA); Mark Oberemk, Toronto (CA); Ryan McColeman, Toronto (CA); Ryan Martin, Toronto (CA)

(21) Appl. No.: 18/375,109

(22) Filed: Sep. 29, 2023

(51) Int. Cl. G06Q 10/087; G06Q 10/0631; G06Q 30/0601

(52) U.S. Cl. CPC G06Q 10/087; G06Q 10/06311; G06Q 30/0639

(57) ABSTRACT

An online concierge system uses images captured for fulfillment of a first order to affect item information of a second order. When a picker fulfills the first order in a physical warehouse, the picker captures an image of the physical warehouse, for example to capture an image of potential replacement items. The online concierge system detects items in the image along with a location of the item in the physical warehouse based on the image. The detected items and respective locations may then be used to modify a second order, for example to route a picker for the second order to updated or alternate locations of the detected items.

### BACKGROUND

Online concierge systems coordinate ordering, pickup, and delivery of orders from a physical warehouse, such as a retailer or other physical space housing a number of physical items. Generally, one type of user (a “customer”) selects items from the physical warehouse for an order and another type of user (a “picker”) fulfills the order by gathering the ordered items (“picking”) from the physical warehouse and delivering the items to the customer. In many instances, the picker for an order may obtain images of the physical warehouse to facilitate the order delivery, for example to aid the customer in selecting a replacement or substitute when an ordered item is unavailable. The picker may use the picker's user device to capture an image of a location of the physical warehouse that includes items that may be feasible alternatives to the ordered item, such that the image may be a relatively easy way for the customer to view and select a replacement item with the captured image.

In addition, the location of items in such a physical warehouse may also change relatively frequently as new items are added, items are out of stock, items have excess stock, and so forth. As such, items may be moved to different locations within the physical warehouse or may be located in multiple locations. The varying location of these items may also make it difficult for the online concierge system to correctly determine the location of items without significant interactions and updates from an operator of the physical warehouse. For example, a grocer who has an excess stock of in-season vegetables may place the vegetables in several positions around a grocery store and may promote the vegetables with a reduced price along with other items in the grocery store. When the grocer does not timely communicate the additional locations (or other relevant information) to the online concierge system, the online concierge system may be unable to effectively account for the additional item positions or promotions in its communications to pickers.

### SUMMARY

In accordance with one or more aspects of the disclosure, an online concierge system uses images captured in relation to one order (e.g., to identify replacement items for the order) to update item information about the physical location for use with another order. As such, the images that may already be captured in relation to improving delivery for one order may be used to improve ordering and fulfillment of future orders while reducing what may otherwise be a manual process to update item information about the physical location. To do so, the captured image for a first order (e.g., for the purpose of identifying replacement items for an unavailable item) is processed to identify items in the image and determine the location of the items with respect to the physical location as a whole. The detected items and location within the physical warehouse is then used to update item information of the detected items. The updated item information may then be used to modify operation and user interfaces with respect to subsequent orders.

For example, one of the detected items may be detected in a location that differs from the currently-stored location of the item in an item database, such that the detected location may be set as an alternate or replacement location of the item. The online concierge system may then use the detected location of the items in the first order to route a picker in the physical warehouse when fulfilling items for another order. Said another way, the routing of the picker for an order and associated user interface displays may be modified to account for the different location of an item in the order that is determined by an image associated with a prior order.

The updated location of items in the warehouse may also be used to recommend or rank items to the customer based on the co-location of items with other items. That is, the updated location of an item may modify the other items that are near the item in the physical warehouse, such that the picker may more easily select items co-located near an item already in the order. In some embodiments, the updated location is used to determine a score for other items in the physical warehouse to rank items to suggest to the customer, such that the customer is encouraged to consider items that have reduced travel by the picker given the updated location of the locations in the physical warehouse. Stated another way, due to the updated item information from images used in fulfilling a prior order, item co-location information may be more effectively determined in evaluating the expected route for a subsequent order.

In additional embodiments, the updated item information may be used to generate a task for a subsequent picker, for example, to confirm automatically determined information or to capture an additional image of the physical warehouse to improve confidence of the determined item information. This allows the image of the prior order to influence additional information gathered by future pickers, both enabling generation of relevant supplemental tasks as well as reducing the need to generate tasks for information that can be successfully inferred from the images of other prior orders.

In addition, the updated information about the items may be used to determine item location and other information about the actual state of items in the physical warehouse without requiring additional tracking devices, monitoring, or intervention from an operator of the physical warehouse. Rather, this information may be automatically gathered from images already used for successful fulfillment of orders, reducing the need for supplemental information gathering to determine a “current” state of the physical warehouse. As some physical warehouses may frequently move and shift the location of items, this approach enables effective real-time updates of item locations without additional information gathering devices or operator input.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 shows one example for detecting items in an image, in accordance with one or more embodiments.

FIG. 4 shows an example map of a physical warehouse, in accordance with one or more embodiments.

FIG. 5 shows an example flow for using identified items from one order to modify operations for another order, in accordance with one or more embodiments.

### DETAILED DESCRIPTION

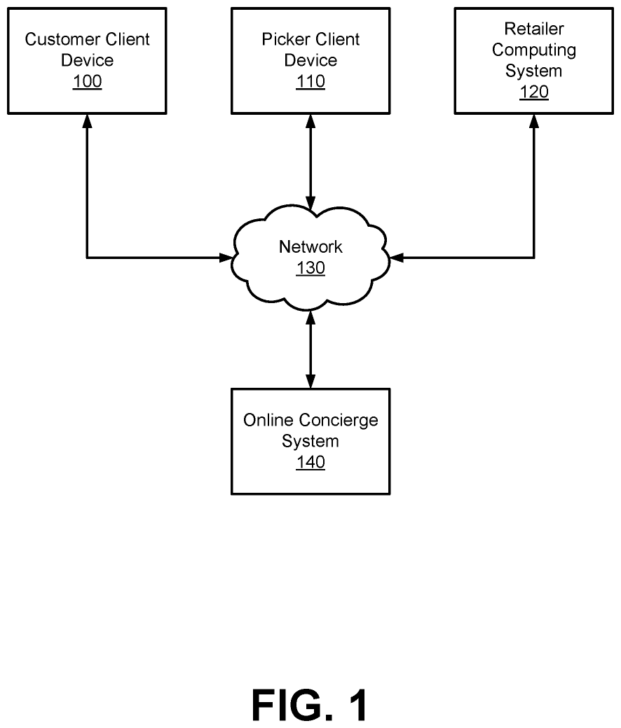

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As a general overview, the picker client device 110 may capture images of portions of a physical warehouse, such as a retailer's physical location, while picking items for an order for a customer. These images may typically be captured to aid in completing the first order, for example when a customer requests additional information about what is available at the warehouse for the order, in relation to replacement items, and in other contexts. In addition to aiding in completing the first order, the online concierge system 140 re-uses the images to identify items in the image and locations of items in the image with respect to one another or within the physical warehouse. This enables the online concierge system 140 to apply information determined from prior orders to inform future orders at the physical warehouse, for example, to route a picker within the warehouse based on the identified locations, or to score items based on proximity determined from the identified locations. This enables the online concierge system 140 to more effectively benefit from images related to prior orders and update item information with re-use of images that may already be captured for order fulfillment and delivery, gaining more current information about the location of items without significant upkeep by an operator of the physical warehouse.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit (SKU) or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

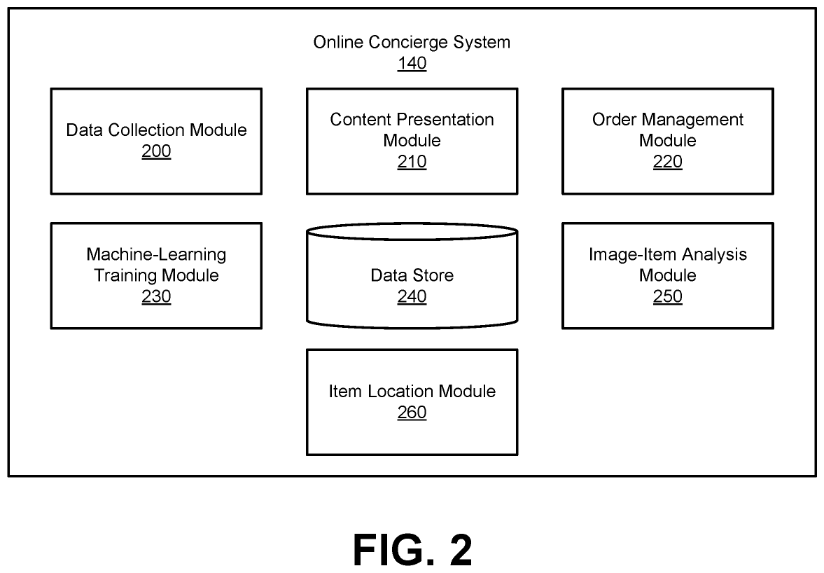

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with one or more embodiments. The system architecture illustrated in FIG. 2 includes a data collection module 200, a content presentation module 210, an order management module 220, a machine-learning training module 230, a data store 240, an image-item analysis module 250, and an item location module 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of the order. In some embodiments, the order management module 220 computes an estimated time of arrival of the picker to the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, hierarchical clustering, and neural networks. Additional examples also include perceptrons, multilayer perceptrons (MLP), convolutional neural networks, recurrent neural networks, sequence-to-sequence models, generative adversarial networks, and transformers. A machine-learning model may include components relating to these different general categories of model, which may be sequenced, layered, or otherwise combined in various configurations.

Each machine-learning model includes a set of parameters. The set of parameters for a machine-learning model are used to process an input and generate an output. For example, a set of parameters for a linear regression model may include weights that are applied to each input variable in the linear combination that comprises the linear regression model. Similarly, the set of parameters for a neural network may include the respective weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes a set of input data for which machine-learning model generates an output. For example, each training example may include customer data, picker data, item data, or order data. In some cases, the training examples also include a label which represents an expected output (i.e., a desired or intended output) of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model, whereby the machine-learning training module 230 updates parameters of the machine-learning model based on each of the set of training examples. The training examples may be processed together, individually, or in batches. To train a machine-learning model based on a training example, the machine-learning training module 230 applies the machine-learning model to the input data in the training example to generate an output with a current set of parameters. The machine-learning training module 230 scores the output from the machine-learning model using a loss function. A loss function is a function that generates a score for the output of the machine-learning model, such that the score is higher when the machine-learning model performs poorly and lower when the machine learning model performs well. In cases where the training example includes a label, the loss function is also based on the label for the training example. Example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory computer-readable media. The data store 240 uses computer-readable media to store data, and may use databases to organize the stored data.

The image-item analysis module 250 receives images from a picker and identifies items and other information about the items (e.g., relational information) from the image. The images may be provided while a picker is at a physical warehouse collecting items to fulfill an order. The image captured by the picker typically depicts a portion of the physical warehouse, such as individual shelves and other areas of the physical warehouse along with various physical objects that correspond to items that are stocked in the physical warehouse and may be available for addition to an order. The image-item analysis module 250 identifies particular items in the image (e.g., analyzes the image to detect particular items) and may also identify a location at which the image was captured. For example, the picker client device may provide a location of the picker client device at the time the image was captured, such as based on sensors of the picker client device. In additional examples, the location may be provided by the picker and may designate a particular location of the picker within the physical warehouse.

These images may be captured by pickers during normal fulfillment of orders. For example, a picker may capture images when a question or other concern arises related to the order. For example, a customer may request an image showing the available options for an item, to select a particular specimen to fulfill the order (e.g., a customer may order a steak and wish to select a specific steak from those available at the butcher), or an item may be out of stock and an image of the area may be used to depict the possible replacement items for the unavailable item. In these various examples, the image captured of the physical warehouse may include a number of different items in the physical warehouse captured in relation to the picker's fulfillment of the current order. In each of these examples, the captured image may include other items in the surrounding areas. As discussed further below, the images captured in relation to the fulfillment of one order may be used to determine item information, such as locations of items (e.g., with respect to one another or the physical warehouse as a whole), used to optimize or modify a subsequent order in conjunction with the item location module 260.

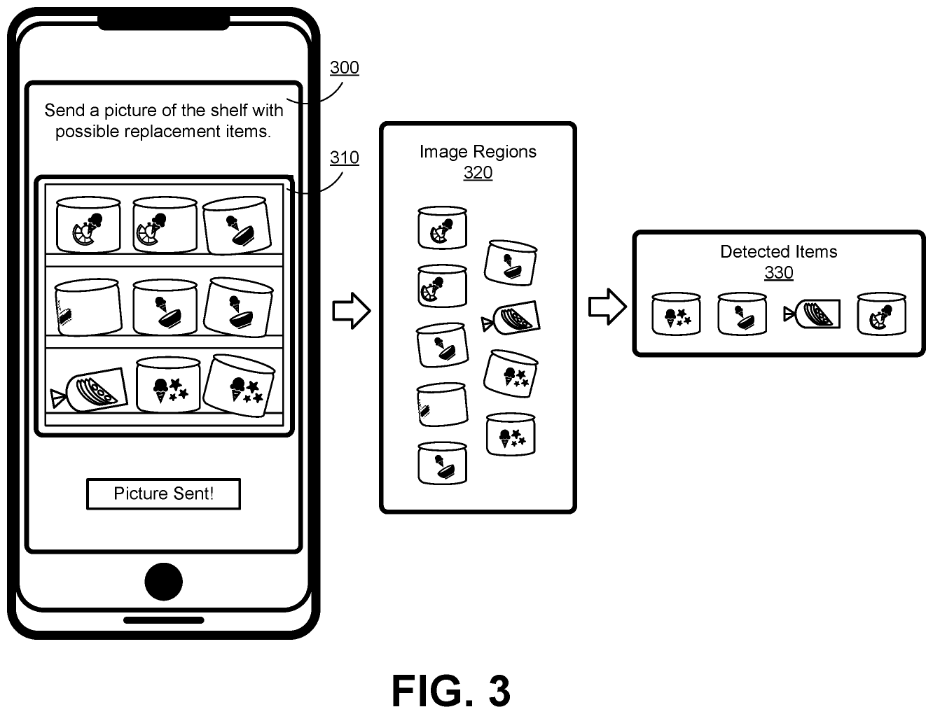

FIG. 3 shows one example for detecting items in an image, in accordance with one or more embodiments. In this example, a user interface 300 may be used on a picker client device when the picker cannot find an ordered item in the physical warehouse and another item may be selected as a replacement. The user interface 300 shown in FIG. 3 illustrates the user interface 300 after a picker has captured an image 310 for the analysis of replacement items. The image captured by the picker is of a physical space captured by the user device, including an area of the physical warehouse by the picker client device 110. The image may include an unknown number of items to be identified and that may have different positions within the image.

The image is then analyzed to detect items in the image, which may include segmenting the image into image regions 320 that likely correspond to individual items and identifying one or more detected items 330 from the image regions. In some embodiments, an item detection algorithm may identify an “image search space” of the types of items that are eligible for identification in the image, such as the known item inventory of a physical warehouse. In some embodiments, an image segmentation algorithm may be applied to the image to identify separate items in the image and segment individual items from one another. Different image segmentation algorithms may be applied in different configurations and embodiments, and may include image segmentation algorithms trained on relevant items (i.e., items particular to the online concierge system or a particular set of items for the location). In the context of the online concierge system coordinating orders for grocery items, such items may include packaged items, such as ice creams, along with loose grocery items such as fresh produce, meats, and other types of items. The image segmentation algorithm in some embodiments may include processes trained on the particular items to be detected and may include identifying associated text or other language elements that may be identifiable on an item (e.g., on an item's label or packaging). As an item may be captured in the image from various perspectives, different aspects of the item may also vary at the different perspectives; from one perspective, the item's name and label may be prominently viewable, while from another perspective, the item's packaging may include only a portion of the item's name and different graphical elements. As such, determining the possible items in the image based on the image search space as discussed above may assist in correctly identifying the items in the image.

Using the portions of the image that may correspond to the possible items (e.g., regions of the image corresponding to the segmented objects in the image), items in the image are detected 330 from the set of possible items. The item detection process may vary in different embodiments and may include any suitable object recognition and classification approach. These may include various ways of characterizing the segmented items in the image (e.g., the portions of the image) and comparing these characterizations to characteristics of the possible items. For example, the segmented image region may be analyzed for particular features or keypoints of the image, described with respect to features as a whole, analyzed with text recognition with respect to a relationship between detected keypoints or other features in the segmented item, and so forth. In some embodiments, the item detection process may include processing by a language model (which can include multi-model analysis for processing input images) that receives the detected text and identifies a most likely item (or a relevance score) in the set of possible items. As one example, a prompt may be constructed for the language model based on item information of the possible items along with the text identified in the image to query the model for a likelihood that the text in the image corresponds to item described by the item identification.

In many cases, the image may include items that are not included in the set of possible items. As such, regions of the image identified by the image segmentation algorithm may not correspond to any of the items in the set of possible items. In one or more embodiments, the segmented image region may be compared with one or more of the possible items to determine a score and/or likelihood that the segmented image region contains an item corresponding to the possible item. In addition to identifying a match between the segmented image region and one of the possible items based on the score(s), the scores may also be used to determine that there is no match between a segmented image region and any of the possible items.

In one or more embodiments, information about relative relationships and positions of the items in the image may also be determined from an analysis of the segmented regions in the image, for example, based on the relationship of the center of mass between image regions or other aspects of the detected items. Such relationships may describe, for example, that one item is above, below, left, right, on, under, behind, or other another positional relationship relative to another item.

As shown in the image 310 and the detected image regions 320, the physical items captured in the image may be viewed from various perspectives as discussed above. In this example, when items are detected from the image regions 320, the detected items 330 may be de-duplicated, such that the image regions that are identified as the same item may not result in additional detected items. In one or more embodiments, the quantity of items in the image may be determined (e.g., from a count of the image regions 320 identified as the same item).

In the example of FIG. 3, the detected items 330 may be further processed to determine which of the detected items may be suitable candidate replacement items for the item that was ordered by the customer. The detected items 330 may be scored or otherwise evaluated as replacement items in a variety of ways. In one or more embodiments, a computer model that scores replacement items may be applied to score each of the detected items with respect to the ordered item, such that items having a threshold score or a number of highest-scoring items (e.g., the top n items) are selected as candidate replacement items. In this example, the detected items 330 include three flavors of ice cream and a bag of peas. When evaluated as a candidate replacement item for the ordered item (an ice cream), the peas may have an insufficient score and is not included in the candidate replacement items. As such, additional steps may also be included for selecting detected items for use with the language model (here, evaluation of the detected items with respect to replacement of the ordered items). In some embodiments, the selection of candidate replacement items may also be based on the language model inputs, for example, by providing a prompt and item information related to the ordered item and the detected items and requesting the language model to determine relevant items as replacements for the ordered item.

As such, pickers may capture images of the physical warehouse in a variety of contexts to aid in fulfilling orders, for example, to identify replacement items as shown in FIG. 3. The image-item analysis module 250 identifies the items in the image for further processing for fulfillment of the order.

Returning to FIG. 2, the item location module 260 may use the identified items in the images from the image-item analysis module 250 for improving ordering and fulfillment of future orders based on the determined location information revealed through the identified images. The item location module 260 obtains a set of items identified in the image along with a location of the picker client device in the physical warehouse when the image was captured to determine the position of items with respect to a map (e.g., a “planogram”) of the physical warehouse. Items in the physical warehouse may be associated with a particular position in the physical warehouse and used for various purposes.

The item location module 260 uses the items identified from the images to verify, update, or supplement item locations of the items in the physical warehouse. To do so, the items detected by the image-item analysis module 250 and the location at which the image was taken (e.g., the location of the picker client device) are used to update the item locations of the items in the map.

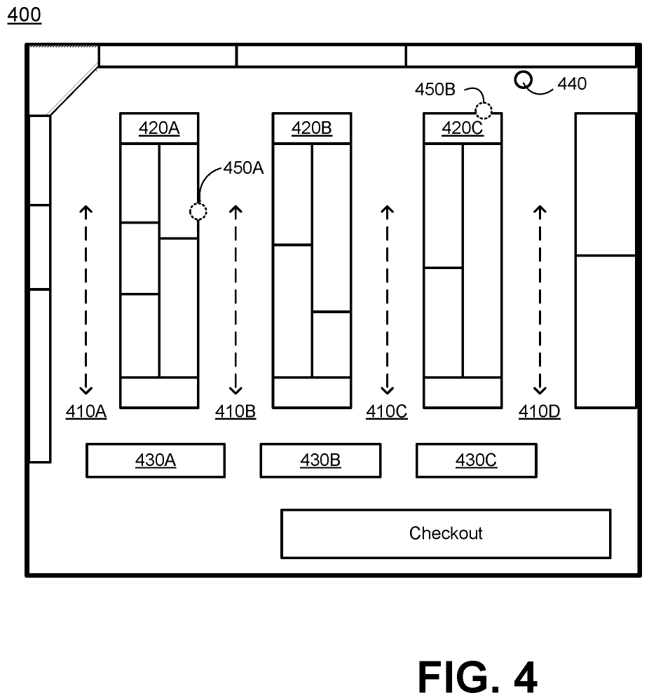

FIG. 4 shows an example map 400 of a physical warehouse, in accordance with one or more embodiments. In the example of FIG. 4, the map 400 shows locations at which items may be placed in the physical warehouse. Locations may be described in different ways in different embodiments and may include various levels of granularity and/or specificity. For example, item locations may be described with respect to particular coordinates or with respect to particular regions or areas of the physical warehouse (e.g., a particular display area, aisle, shelf, and so forth). In the example of FIG. 4, various areas are shown in which an item may be located in the physical warehouse, such as particular shelves in a grocery store. In this example, the map 400 includes a number of aisles 410A-D having endcaps 420A-C, and display areas 430A-C. In various implementations, the map of a physical location may include any number of areas to sufficiently describe where items may be positioned within the physical warehouse and may include more or less specificity. In some embodiments, the particular map of the physical warehouse may be provided by an operator of the physical warehouse, and in others may be determined by another operator or inferred based on images from pickers or other means.

The various items available at the physical warehouse may be associated with one or more locations in the physical warehouse. The item location module 260 uses the detected items in images to update the location of items in the map 400. For example, a picker may capture an image of aisle 410D from a location 440. The location of the picker client device is determined based on sensors in the picker client device and/or information from the picker and used to determine a location 440 at which the image was captured along with the relevant areas of the physical warehouse shown in the image. By determining the location 440 at which the image was captured and the respective areas in the physical warehouse shown in the image, the item location module 260 determines the locations of detected items in the image with respect to areas of the physical warehouse, for example, to determine that detected items for an image captured at location 440 are associated with aisle 410D. In the example of FIG. 4, an item may be associated with one location 450A in aisle 410B and, also be detected in the image captured by the picker device at location 440, associating the item with another location 450B on endcap 420C.

The particular area to associate with items (e.g., aisle 410D or endcap 420C) shown in the image may also be determined or inferred by the item location module 260, for example, by analyzing signage or other labeling within the image associated with the areas or the stored location of one or more detected items (e.g., when the stored location information for items matches a particular location in the warehouse). In various embodiments, the particular location to associate with detected items may also be requested from or confirmed by the picker. In addition, the image may include multiple areas of the physical warehouse, such that different items may be associated with different regions in the map. Thus, one item detected in the image captured at location 440 may be associated with the aisle 410D and another item detected in the image may be associated with the endcap 420C. In some examples, the analysis of the image may thus include distinguishing whether items were identified at different portions of the physical warehouse, such as a particular aisle, endcap, or freestanding display.

The detected location of items based on the image may then be used to update the stored item locations. The detected location may be used to confirm the location of an item, replace a prior location, or provide an alternate location of the item. For example, a particular item, in the item database, may be associated with a particular shelf in the aisle 410B for the physical warehouse. This location may have been set, for example, by an operator of the physical warehouse, indicating to the online concierge system 140 the intended layout of items at the time that the operator set the item location. Over time, however, the location of items may be changed, or items may be placed in additional or alternative locations. When a new location of the item occurs based on the image analysis that differs from the location in the item database, the item location is updated accordingly. In this example, the item may be associated with aisle 410B in the item database (e.g., at location 450A), but the image analysis discussed above identifies the same item as being present at endcap 420C (e.g., at location 450B).

The location of the item may then be updated to change the location to the newly-detected location or to add the detected location as an alternate location for the item. In some embodiments, whether to add the detected location as an alternate location or to replace the previous location may be determined based on whether the item was recently fulfilled by a picker at the previous location or based on the particular detected location (e.g., its type). For example, certain types of detected locations may be associated with alternative locations for the item that are often temporary, such as portions of the physical warehouse that may generally include items that are promoted, on sale, or overstock. These particular locations may often have different items placed in that location as the promoted items change over time, while the items may also be located in the original location. As one example, an item may typically be associated with a location in an aisle, and placed in an endcap as part of a promotion, such that the same item may be located at multiple places within the physical warehouse. In addition to locating intentionally-stocked items, the identification of items may also include identifying items that have been misplaced or inadvertently-located in other areas. By detecting these items in images of the physical warehouse already being taken by pickers fulfilling orders, the non-designated locations may be identified and used by the online concierge system 140, for example to identify that an item indicated as out-of-stock or unavailable at a typical location is available at another.

As such, by analyzing images captured for previous orders for item locations, the online concierge system 140 may account for changing conditions within the physical warehouse without requiring additional image capture or analysis within the store or direct input from an operator to update the location of items at the online concierge system 140.

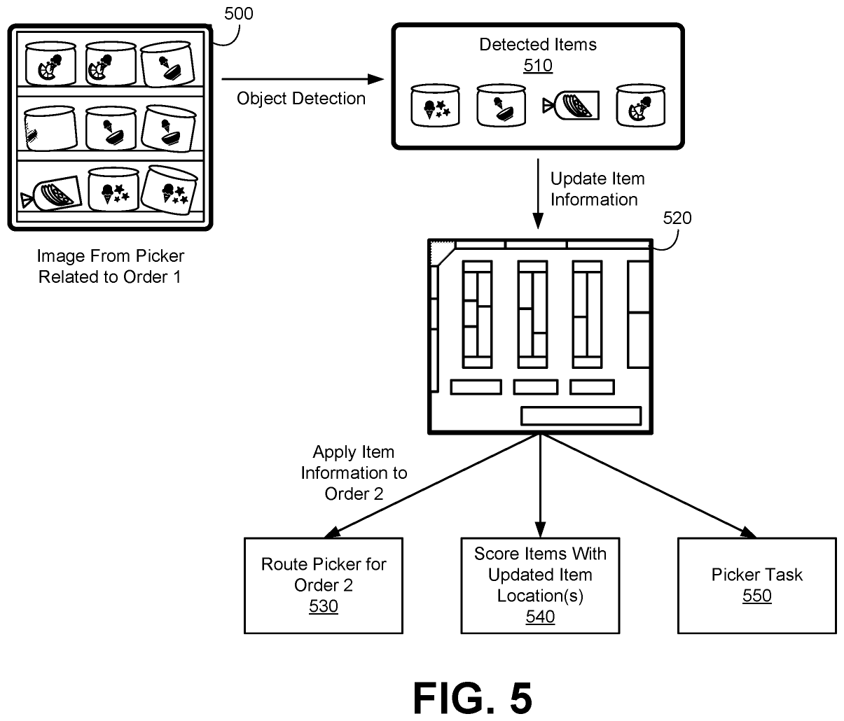

FIG. 5 shows an example flow for using identified items from one order to modify operations for another order, in accordance with one or more embodiments. As discussed above, an image 500 may be provided from the picker of an order (e.g., a first order) in a variety of contexts, such as a replacement order or to provide additional information to a customer. The image may be processed, such as by the image-item analysis module 250, to identify one or more detected items 510 in the image. Then, the location of the items may be determined with respect to the physical warehouse and used to update a map 520 as discussed above, e.g., by with respect to FIG. 4.

The updated item information (such as locations based on the detected items for images captured for a first order) may then be used to modify performance related to a second order in various ways. The updated information may be applied to modify related user interfaces for various features of the online concierge system 140. A few example actions for modifying the second order are discussed below; any combination of which may be used in various embodiments along with different and/or additional actions.

As one way of modifying a second order, the updated item information may be used to modify a route 530 or suggested path through the physical location for a picker fulfilling the second order. The route may be displayed to the picker during the picker's fulfillment of the second order and account for the updated item location, such as an alternate location of an item in the order as determined based on the identification of that item in the alternate location when the image 500 is analyzed for the first order. As such, the updated and/or alternate locations for obtaining the item may be used to further optimize the path of a picker through the physical location. One example implementation of picker routing is provided in U.S. patent application Ser. No. 17/855,793, filed Jul. 1, 2022, the contents of which are hereby incorporated by reference. In addition to routing the picker based on updated and/or alternate item locations, in instances in which the detected items 510 include an item previously considered out-of-stock or only at another location (e.g., the item may be detected in a location that is not the intended location for the item), the picker may be routed to the detected location to obtain the detected item that would otherwise be considered for replacement in the order, enabling fulfillment of successful items that are not properly placed within the store.

In addition to routing users, the updated item information may affect item scoring 540 for various purposes. For example, items in some embodiments may be scored 540 based on the relative proximity of the items to other items in the physical location. In some embodiments, items in a user's order may be used to affect the relative placement or scoring of other items in the order, such that the user may be encouraged to order items that are near other items and thus generate an order that minimizes additional travel within the physical warehouse by the picker. To do so, the updated item locations in the map may affect scoring of items based on co-location of items with respect to others. When items are ranked for display to a customer in the user interface of the customer's client device, the underlying scoring for the ranking may include a factor based on the locational similarity of items already in the user's order (e.g., a “shopping list” or “cart” assembled before completing the order). By updating the locational information based on the detected items related to the first order, this scoring for a second order may more correctly account for the actual co-location of items in the physical warehouse, such that the co-location scoring correctly accounts for the actual location of items.

In addition, as discussed above, the placement of items to particular locations in the physical warehouse may also indicate a promotion, sale, or other preference for a customer ordering the item. In one or more embodiments, identifying that an item is in one of these areas may also increase the likelihood that the item is promoted to the customer, or the online concierge system 140 may retrieve a current price from the retailer computing system 120 to determine whether the item is on sale or otherwise promoted based on the detected item location.

As a final example action, the updated item information may also be used to determine a task 550 or other activity for the picker of the second order. When the detected items 510 include items that are in different locations than the locations that an item was previously associated with, whether the item has permanently moved or been located at multiple locations may be verified by generating a task for another picker. The task may designate for the picker to capture an image of the original location of the item to determine what items are currently at that location. The task may be provided to a picker who is already fulfilling items in the vicinity of the original location, such that the additional task does not increase the amount of time required for the picker of the second order. As another example, the task 540 may include confirming the updated location of the items of the order at the detected location.

As such, together these approaches enable repurposing of images and item detection related to one order to supplement and improve activity related to a second order, for example to improve picker routing, item location-based scoring, and generate related tasks to confirm item locations.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example; comparing an output of the machine-learning model to the label associated with the training example; and updating weights associated for the machine-learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving an image of an area of a physical warehouse, the image captured by a user device operated by a picker fulfilling a first order;
applying a machine-learned model to the image to generate a set of items that are depicted in the image of the area of the physical warehouse;
generating information about a location of the set of items in the physical warehouse based on the determined set of items in the image and a location of the user device operated by the picker when the image was captured; and
modifying a user interface for a second order based on the determined information about the items, wherein the modifying comprises causing another user device operated by another picker to display the determined information.

2. The method of claim 1, further comprising:
generating a route for fulfilling items in the second order, the generating based on the determined information;
wherein the modified user interface includes the route for fulfilling the second order.

3. The method of claim 1, further comprising:
generating a proximity score for at least one of the set of items relative to one or more items in the second order relative to the determined information about the location of the set of items; and
generating a ranking of at least one of the set of items for presentation to a user based on the proximity score;
wherein modifying the user interface includes presenting the ranking based on the proximity score.

4. The method of claim 1, wherein the generated information about the location of the set of items is an alternate location of the items.

5. The method of claim 1, further comprising:
determining that an item is available for inclusion in the second order, wherein the determining is based on determining a set of items that are depicted in the image of the area of the physical warehouse.

6. The method of claim 1, further comprising:
assigning a task for a picker of the second order to determine supplemental item information about one or more other items at the location in the warehouse;
wherein modifying the user interface comprises displaying the task to the picker of the second order while the picker is in the physical warehouse.

7. The method of claim 1, wherein the machine-learned model is trained by, repeatedly:
inputting a training image to the machine-learned model, wherein the machine-learned model outputs a probability that a specific item is depicted in the training image;
comparing the probability to a label that indicates whether the specific item is actually depicted in the training image; and
updating the machine-learned model based on the comparing.

8. A computer program product comprising a non-transitory computer readable storage medium having instructions encoded thereon that, when executed by a processor, cause the processor to perform steps comprising:
receiving an image of an area of a physical warehouse, the image captured by a user device operated by a picker fulfilling a first order;
applying a machine-learned model to the image to generate a set of items that are depicted in the image of the area of the physical warehouse;
generating information about a location of the set of items in the physical warehouse based on the determined set of items in the image and a location of the user device operated by the picker when the image was captured; and
modifying a user interface for a second order based on the determined information about the items, wherein the modifying comprises causing another user device operated by another picker to display the determined information.

9. The non-transitory computer readable medium storage of claim 8, wherein the instructions further cause the processor to perform steps comprising:
generating a route for fulfilling items in the second order, the generating based on the determined information;
wherein the modified user interface includes the route for fulfilling the second order.

10. The non-transitory computer readable medium storage of claim 8, wherein the instructions further cause the processor to perform steps comprising:
generating a proximity score for at least one of the set of items relative to one or more items in the second order relative to the determined information about the location of the set of items; and
generating a ranking of at least one of the set of items for presentation to a user based on the proximity score;
wherein modifying the user interface includes presenting the ranking based on the proximity score.

11. The non-transitory computer readable medium storage of claim 8, wherein the generated information about the location of the set of items is an alternate location of the items.

12. The non-transitory computer readable medium storage of claim 8, wherein the instructions further cause the processor to perform steps comprising:
determining that an item is available for inclusion in the second order, wherein the determining is based on determining a set of items that are depicted in the image of the area of the physical warehouse.

13. The non-transitory computer readable medium storage of claim 8, wherein the instructions further cause the processor to perform steps comprising:
assigning a task for a picker of the second order to determine supplemental item information about one or more other items at the location in the warehouse;
wherein modifying the user interface comprises displaying the task to the picker of the second order while the picker is in the physical warehouse.

14. The non-transitory computer readable medium storage of claim 8, wherein the instructions further cause the processor to perform steps comprising:
inputting a training image to the machine-learned model, wherein the machine-learned model outputs a probability that a specific item is depicted in the training image;
comparing the probability to a label that indicates whether the specific item is actually depicted in the training image; and
updating the machine-learned model based on the comparing.

15. A system comprising:
a processor that executes instructions; and
a non-transitory computer-readable storage medium having instructions executable by the processor for:
receiving an image of an area of a physical warehouse, the image captured by a user device operated by a picker fulfilling a first order;
applying a machine-learned model to the image to generate a set of items that are depicted in the image of the area of the physical warehouse;
generating information about a location of the set of items in the physical warehouse based on the determined set of items in the image and a location of the user device operated by the picker when the image was captured; and
modifying a user interface for a second order based on the determined information about the items, wherein the modifying comprises causing another user device operated by another picker to display the determined information.

16. The system of claim 15, wherein the instructions are further executable for:
generating a route for fulfilling items in the second order, the generating based on the determined information;
wherein the modified user interface includes the route for fulfilling the second order.

17. The system of claim 15, wherein the instructions are further executable for:
generating a proximity score for at least one of the set of items relative to one or more items in the second order relative to the determined information about the location of the set of items; and
generating a ranking of at least one of the set of items for presentation to a user based on the proximity score;
wherein modifying the user interface includes presenting the ranking based on the proximity score.

18. The system of claim 15, wherein the generated information about the location of the set of items is an alternate location of the items.

19. The system of claim 15, wherein the instructions are further executable for:
determining that an item is available for inclusion in the second order, wherein the determining is based on determining a set of items that are depicted in the image of the area of the physical warehouse.

20. The system of claim 15, wherein the instructions are further executable for:
assigning a task for a picker of the second order to determine supplemental item information about one or more other items at the location in the warehouse;
wherein modifying the user interface comprises displaying the task to the picker of the second order while the picker is in the physical warehouse.
